(19) United States
(12) Patent Application Publication
(10) Pub. No.: US 2014/0179173 A1
(43) Pub. Date: Jun. 26, 2014

(54) PRESS-FIT TERMINAL FOR BOARD CONNECTOR AND FIXING STRUCTURE OF PRESS-FIT TERMINAL TO CONNECTOR HOUSING

(71) Applicant: Yazaki Corporation, Tokyo (JP)

(72) Inventors: Etsurou SUZUKI, Makinohara-shi (JP); Yasuharu KONDO, Makinohara-shi (JP)

(73) Assignee: Yazaki Corporation, Tokyo (JP)

(21) Appl. No.: 14/192,166

(22) Filed: Feb. 27, 2014

Related U.S. Application Data
(63) Continuation of application No. PCT/JP2012/071741, filed on Aug. 22, 2012.

(30) Foreign Application Priority Data
Aug. 29, 2011 (JP) 2011-186285

(51) Int. Cl. H01R 13/42

(52) U.S. Cl. CPC H01R 13/42
USPC 439/751

(57) ABSTRACT

A press-fit terminal includes an electric connecting part provided in a front part of the press-fit terminal to be electrically connected to a mating connector terminal; a rear leg part provided in a rear part of the press-fit terminal to be inserted and fixed to a through hole of a circuit board; and an engaging part provided in an intermediate part between the electric connecting part and the rear leg part to be press-fitted to a press-fit hole of a wall part of a connector housing. The rear leg part is formed in a shape of a round pin having a circular form in cross-section. The rear leg part may be designed to have a diameter in cross-section being smaller than a minimum dimension between opposed inner wall surfaces of the press-fit hole of the connector housing.

### CROSS REFERENCE TO RELATED APPLICATIONS

This application is a continuation of PCT application No. PCT/JP2012/071741, which was filed on Aug. 22, 2012 based on Japanese Patent Application (No. 2011-186285) filed on Aug. 29, 2011, the contents of which are incorporated herein by reference.

### BACKGROUND OF THE INVENTION

1. Field of the Invention

The present invention relates to a press-fit terminal for a board connector and a fixing structure of the press-fit terminal to a connector housing.

2. Description of the Related Art

A board connector is known, for example, in JP-A-2006-100231 that a terminal is press-fitted and fixed to a press-fit hole formed in a wall part of a connector housing. In this kind of connector, the press-fit hole is formed which passes through in a back and forth direction of the rear wall of the connector housing that is made of a resin. A pin shaped male terminal is press-fitted to the press-fit hole, so that the press-fit terminal is fixed to the connector housing under a state that an electric contact part of a front end electrically connected to a mating connector terminal is located in a fitting hood part of the connector housing and a rear leg part of a rear end to be soldered to a circuit board is allowed to protrude to a rear side of the connector housing.

Since the press-fit terminal used in this kind of board connector is manufactured by press forming a metal plate, an entire part of the press-fit terminal from the electric connecting part of the front end to the rear leg part of the rear end is ordinarily formed in the shape of a square pin having a square shape in cross-section.

### SUMMARY OF THE INVENTION

When the rear leg part of each terminal is soldered to a circuit board, the rear leg part may be occasionally inserted into a through hole and soldered. In such a way, when the rear leg part is inserted into the through hole and soldered, if a cross-section of the rear leg part has a square shape, since a length of a diagonal line of the cross-section is a maximum dimension, a diameter of the through hole needs to be determined so as to correspond to the length of the diagonal line. In that case, however, the diameter of the through hole is liable to be large. As a result, it is recognized that a pitch of the through hole is large, which is an obstacle to an integration of a circuit or a miniaturization of a circuit board.

Further, it is recognized that when the terminal is press-fitted to the press-fit hole of the connector housing, if the rear leg part is firstly inserted into the press-fit hole, the rear leg part rubs an inner wall of the press-fit hole so that a plating on the surface of the terminal may possibly peel to generate a soldering failure when the rear leg part is soldered.

The present invention is devised by considering the above-described circumstances and it is an object of the present invention to provide a press-fit terminal for a board connector and a fixing structure of a press-fit terminal to a connector housing which can prevent a plating of a rear leg part from peeling during a press-fit operation and can reduce a diameter of a through hole for soldering the rear leg part so that a circuit may be integrated and a circuit board may be miniaturized.

The above object may be achieved by any of the following configuration of the present invention:

(1) A press-fit terminal for a base board connector, the press-fit terminal including: an electric connecting part which is provided in a front part of the press-fit terminal to be electrically connected to a mating connector terminal; a rear leg part which is provided in a rear part of the press-fit terminal to be inserted and fixed to a through hole of a circuit board; and an engaging part which is provided in an intermediate part between the electric connecting part and the rear leg part to be press-fitted to a press-fit hole of a wall part of a connector housing and engaged with the wall part of the connector housing, wherein a range from the electric connecting part to the engaging part is formed in a shape of a square pin having a square form in cross-section, and the rear leg part is formed in a shape of a round pin having a circular form in cross-section.

(2) The press-fit terminal according to the configuration (1), wherein the rear leg part is designed to have a diameter in cross-section being smaller than a minimum dimension between opposed inner wall surfaces of the press-fit hole of the connector housing.

(3) The press-fit terminal according to the configuration (1) or (2), wherein the engaging part includes: a stopper protrusion which is protruded in a width direction of the press-fit terminal to regulate an inserting position of the terminal when the terminal is press-fitted to the press-fit hole of the connector housing; and an engaging protrusion which is protruded in the width direction of the press-fit terminal to prevent the press-fit terminal from slipping out.

(4) A fixing structure of a press-fit terminal to a connector housing, the connector housing including a press-fit hole passing through a wall part of the connector housing, and the press-fit terminal including: an electric connecting part which is provided in a front part of the press-fit terminal to be electrically connected to a mating connector terminal; a rear leg part which is provided in a rear part of the press-fit terminal to be inserted and fixed to a through hole of a circuit board; and an engaging part which is provided in an intermediate part between the electric connecting part and the rear leg part, and press-fitted to the press-fit hole of the connector housing and engaged with the wall part of the connector housing, wherein the rear leg part is inserted into the press-fit hole of the connector housing from a front side to a rear side of the press-fit hole to fix the press-fit terminal to the connecting housing, a range from the electric connecting part to the engaging part of the press-fit terminal is formed in a shape of a square pin having a square form in cross-section, and the rear leg part is formed in a shape of a round pin having a circular form in cross-section.

(5) The fixing structure according to the configuration (4), wherein the rear leg part has a diameter in cross-section being smaller than a minimum dimension between opposed inner wall surfaces of the press-fit hole of the connector housing.

(6) The fixing structure according to the configuration (4) or (5), wherein the engaging part includes: a stopper protrusion which is protruded in a width direction of the press-fit terminal and abutted against an engaging wall of a front side of the press-fit hole to regulate an inserting position of the press-fit terminal when the terminal is press-fitted to the press-fit hole; and an engaging protrusion which is protruded in the width direction of the press-fit terminal and engaged with an engaging wall of a rear side of the press-fit hole after the press-fit terminal passes through the press-fit hole to prevent the terminal from slipping out, wherein the press-fit terminal is engaged with the connecting housing at a fixed position by the stopper protrusion and the engaging protrusion when the rear leg part is inserted into the press-fit hole of the connector housing from the front side to the rear side of the press-fit hole.

According to the press-fit terminal having the configuration (1), since the rear leg part to be inserted into the through hole of the circuit board is not formed in the shape of a square pin having a square form in cross-section, but formed in the shape of the round pin having the circular form in cross-section, a diameter of the through hole can be made to be smaller than that of a through hole into which the square pin shaped rear leg part having the same sectional area is inserted. Namely, in the case of the square pin, since a length of a diagonal line of the square shaped section is a maximum dimension, a diameter of the through hole needs to be set so as to meet the length of the diagonal line. In the case of the round pin, however, since a maximum dimension (a diameter) can be made to be smaller than the length of the diagonal line even in the same sectional area, the diameter of the through hole into which the round pin is inserted can be made to be smaller than the diameter of the through hole into which the square pin is inserted. As a result, the pitch of the through hole can be reduced, so that an integration of a circuit of the circuit board or a miniaturization of the circuit board can be achieved.

According to the press-fit terminal having the configuration (2), since the rear leg part to be fixed or soldered to the circuit board is formed in the shape of the round pin having the circular form in cross-section in which the diameter is smaller than the minimum dimension between the opposed inner wall surfaces of the press-fit hole of the connector housing, when the terminal is press-fitted to the press-fit hole firstly from its rear leg part, the rear leg part does not come into contact with the inner wall of the press-fit hole of the connector housing and can be inserted into the press-fit hole. Accordingly, a plating on the surface of the round pin shaped rear leg part can be prevented from rubbing the inner wall of the press-fit hole and peeling, and a situation can be avoided that a substrate is exposed due to the peeling of the plating so that a soldering failure of the rear leg part occurs.

According to the press-fit terminal having the configuration (3), since the press-fit terminal is inserted into the press-fit hole of the connector housing firstly from its rear leg part, the press-fit terminal can be fixed to the connector housing at a prescribed position under a state that the inserting position of the press-fit terminal is regulated by the stopper protrusion and the press-fit terminal is prevented from slipping out by the engaging protrusion.

According to the fixing structure of the press-fit terminal having the configuration (4), since the rear leg part inserted into the through hole of the circuit board is not formed in the shape of a square pin having a square form in cross-section, but formed in the shape of the round pin having the circular form in cross-section, a diameter of the through hole can be made to be smaller than that of a through hole into which the square pin shaped rear leg part having the same sectional area is inserted. Namely, in the case of the square pin, since a length of a diagonal line of the square shaped section is a maximum dimension, a diameter of the through hole needs to be set so as to meet the length of the diagonal line. However, in the case of the round pin, since a maximum dimension (a diameter) can be made to be smaller than the length of the diagonal line even in the same sectional area, the diameter of the through hole into which the round pin is inserted can be made to be smaller than the diameter of the through hole into which the square pin is inserted. As a result, the pitch of the through hole can be reduced, so that an integration of a circuit of the circuit board or a miniaturization of the circuit board can be achieved.

According to the fixing structure of the press-fit terminal having the configuration (5), since the rear leg part soldered to the circuit board is formed in the shape of the round pin having the circular form in cross-section in which the diameter is smaller than the minimum dimension between the opposed inner wall surfaces of the press-fit hole of the connector housing, when the terminal is press-fitted to the press-fit hole firstly from its rear leg part, the rear leg part does not come into contact with the inner wall of the press-fit hole of the connector housing and can be inserted into the press-fit hole. Accordingly, a plating on the surface of the round pin shaped rear leg part can be prevented from rubbing the inner wall of the press-fit hole and peeling, and a situation can be avoided that that a substrate is exposed due to the peeling of the plating so that a soldering failure of the rear leg part occurs.

According to the fixing structure of the press-fit terminal having the configuration (6), since the press-fit terminal includes, as the engaging part, the stopper protrusion and the engaging protrusion respectively engaged with the engaging wall of the front side and the engaging wall of the rear side of the press-fit hole, when the press-fit terminal is inserted into the press-fit hole of the connector housing firstly from its rear leg part, the press-fit terminal can be fixed to the connector housing at a prescribed position under a state that the inserting position of the press-fit terminal is regulated by the stopper protrusion and the press-fit terminal is prevented from slipping out by the engaging protrusion.

According to aspects of the present invention, the plating of the rear leg part can be prevented from peeling when the rear leg part is press-fitted to the connector housing and the diameter of the through hole for soldering the rear leg part can be reduced, so that the circuit can be integrated and the board can be miniaturized.

### BRIEF DESCRIPTION OF THE DRAWINGS

FIG. 1A is a perspective view showing a state before a press-fit terminal is press-fitted to a press-fit hole formed in a wall part (only a part of the wall part is shown) of a connector housing according to an embodiment of the present invention.

FIG. 1B is a diagram seen from a front side of the press-fit hole to show a dimensional relation between a rear leg part of the press-fit terminal and the press-fit hole.

FIG. 2 is a perspective view showing a state when the rear leg part of the press-fit terminal according to the embodiment begins to be inserted into the press-fit hole of the connector housing.

FIG. 3 is a perspective view showing a state that the press-fit terminal according to the embodiment is press-fitted and fixed to the press-fit hole of the connector housing.

FIGS. 4A and 4B are diagrams showing a relation between a cross-sectional form of the rear leg part and a diameter of a through hole when the rear leg part of the press-fit terminal is inserted into the through hole of a circuit board, in which FIG. 4A shows the embodiment of the present invention in which the rear leg part is formed in a round pin having a circular form in cross-section and FIG. 4B is a comparative example in which a rear leg part is formed in a square pin having a square form in cross-section.

### DETAILED DESCRIPTION OF THE EXEMPLARY EMBODIMENTS

Now, an embodiment of the present invention will be described below by referring to the drawings.

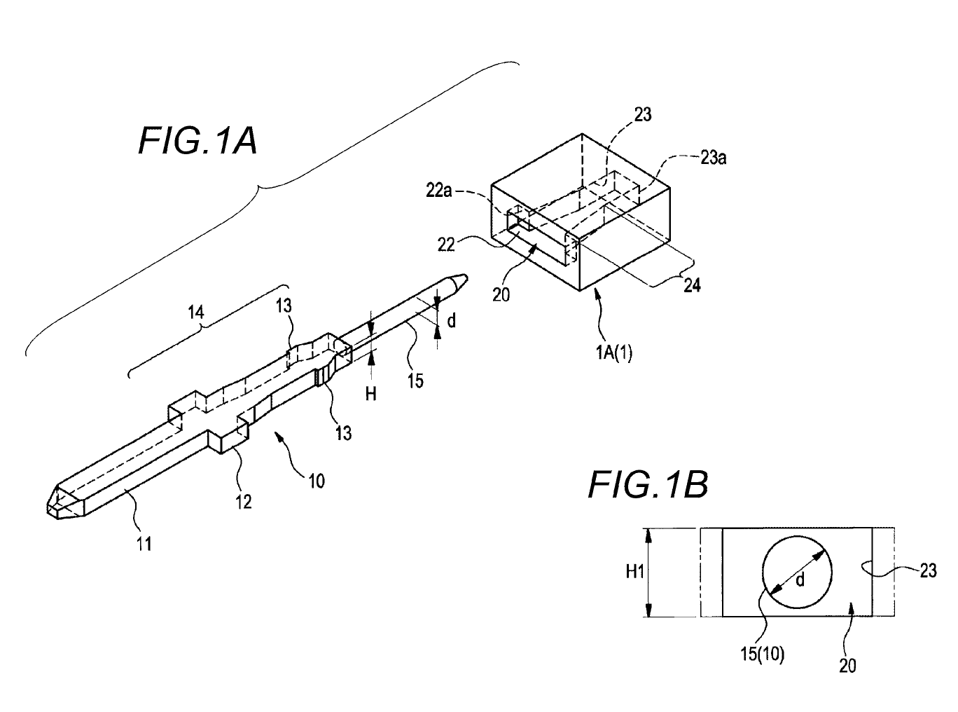

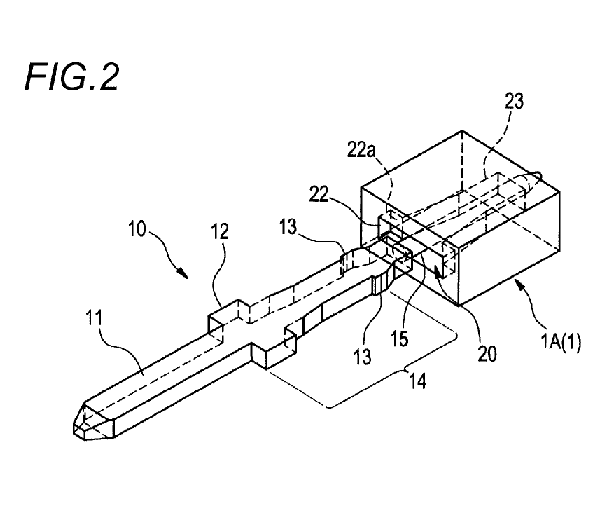

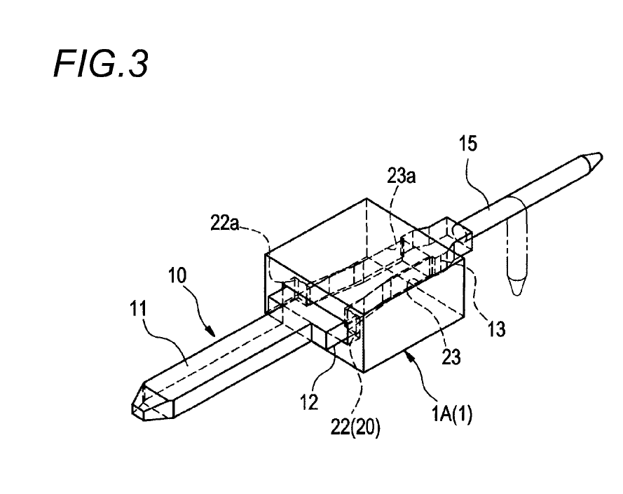

FIG. 1A is a perspective view showing a state before a press-fit terminal is press-fitted to a press-fit hole formed in a wall part (only a part of the wall part is shown) of a connector housing. FIG. 1B is a diagram seen from a front side of the press-fit hole and showing a dimensional relation between a rear leg part of the press-fit terminal and the press-fit hole. FIG. 2 is a perspective view showing a state when the rear leg part of the press-fit terminal begins to be inserted into the press-fit hole of the connector housing. FIG. 3 is a perspective view showing a state that the press-fit terminal is press-fitted and fixed to the press-fit hole of the connector housing.

A press-fit terminal 10 according to the embodiment is formed, as shown in FIG. 1A, of a metal member (copper, aluminum, aluminum alloy or the like) which is formed in the shape of a pin as a whole, and includes an electric connecting part 11 to be electrically connected to a mating connector terminal at a front part in a longitudinal direction, a rear leg part 15 inserted and soldered (fixed) to a through hole of a circuit board in a rear part and an engaging part 14 press-fitted to a press-fit hole 20 passing through a wall part 1A of a connector housing 1 made of a resin and engaged with the wall part 1A of the connector housing 1 in an intermediate part between the electric connecting part 11 and the rear leg part 15. In order to improve a contact conductivity of the electric connecting part 11 or a soldering property of the rear leg part 15, a surface of an entire part of the press-fit terminal is plated with tin or the like.

As shown in FIG. 2 and FIG. 3, the press-fit terminal 10 is a press-fit terminal for a base board connector fixed to the connector housing 1 by the engaging part 14 by inserting the rear leg part 15 into the press-fit hole 20 of the connector housing 1 from a front side to a rear side of the press-fit hole 20. A range from the electric connecting part 11 to the engaging part 14 of the press-fit terminal is formed in the shape of a square pin having a square form in cross-section and the thickness of H. The rear leg part 15 is formed in the shape of a round pin having a circular form in cross-section in which a diameter d is smaller than a minimum dimension H1 between opposed inner wall surfaces of the press-fit hole 20 of the connector housing 1. Here, a relation expressed by “H1>d” is established.

Further, in the press-fit terminal 10, the engaging part 14 includes a stopper protrusion 12 abutted against an engaging wall 22a of a front side of the press-fit hole 20 to regulate an inserting position of the terminal 10 when the terminal 10 is press-fitted to the press-fit hole 20. The engaging part further includes an engaging protrusion 13 engaged with an engaging wall 23a of a rear side of the press-fit hole 20 after passing though the press-fit hole 20 to prevent the terminal 10 from slipping out. The stopper protrusion 12 and the engaging protrusion 13 respectively protrude on both right and left side surfaces of the engaging part 14 having the square form in cross-section.

The press-fit hole 20 of the connector housing 1 is provided in the wall part 1A of a rear end of a fitting hood part (an illustration is omitted) of the connector housing 1 as a through hole having a rectangular form in cross-section. The press-fit hole 20 has, in the front side, a recessed part 22 to which the stopper protrusion 12 is fitted, and, in the rear side, a press-fit part 23 whose sectional dimension is set to be substantially equal to a cross-sectional dimension of the engaging part 14 of the press-fit terminal 10. Here, the minimum dimension H1 between the opposed inner wall surfaces of the press-fit part 23 is a dimension between upper and lower inner wall surfaces corresponding to a direction of thickness of the press-fit terminal 10. Further, a section 24 between the recessed part 22 and the press-fit part 23 is an inclined section which is set to a dimension with an allowance slightly more than a cross-sectional dimension of the engaging part 14 so that the engaging part 14 of the press-fit terminal 10 may be easily inserted. An inclination of the inclined section is provided especially in both the right and left side surfaces. A bottom wall of the recessed part 22 serves as the engaging wall 22a of the front side against which the stopper protrusion 12 is abutted and a wall in the periphery of an exit of the press-fit part 23 serves as the engaging wall 23a of the rear side with which the stopper protrusion 13 is engaged.

When the press-fit terminal 10 is attached to the press-fit hole 20 of the connector housing 1, as shown in FIG. 2, the rear leg part 15 formed in the shape of the round pin is inserted into the press-fit hole 20 from the front side of the press-fit hole 20. When the rear leg part 15 is inserted into the press-fit hole 20, since the diameter d of the rear leg part 15 is (at least so designed to be) smaller than the minimum dimension H1 between the opposed inner wall surfaces of the oppress-fit hole 20, the rear leg part 15 does not come into contact with the inner wall of the press-fit hole 20 and can be inserted into the press-fit hole 20.

As the rear leg part 15 passes through the press-fit hole 20, the engaging protrusion 13 of the press-fit terminal 10 reaches the press-fit part 23 of the press-fit hole 20. Since a dimension between right and left ends of the right and left engaging protrusions 13 is set to be larger than a dimension of a width between right and left sides of the press-fit part 23, the engaging protrusion 13 rubs the inner wall of the press-fit part 23 and is press-fitted. As shown in FIG. 3, when the engaging protrusion 13 passes through the press-fit part 23, the engaging protrusion 13 is engaged with the engaging wall 23a of the rear side of the press-fit hole 20 to prevent the press-fit terminal 10 from slipping out. At the same time, the stopper protrusion 12 is abutted against the engaging wall 22a of the front side as the bottom wall of the recessed part 22 to regulate the inserting position of the press-fit terminal 10. Then, the press-fit terminal 10 is engaged with the connector housing 1 at a fixed position by the stopper protrusion 12 and the engaging protrusion 13, so that a fixing structure of the press-fit terminal 10 shown in FIG. 3 is formed.

When the press-fit terminal 10 is attached to the press-fit hole 20 as described above, since the rear leg part 15 of the press-fit terminal 10 does not come into contact with the inner wall of the press-fit hole 20 of the connector housing 1 and can be inserted into the press-fit hole 20, a plating on the surface of the round pin shaped rear leg part 15 can be prevented from rubbing the inner wall of the press-fit hole 20 and peeling. Accordingly, a situation can be avoided that that a substrate is exposed due to the peeling of the plating so that a soldering failure occurs when the rear leg part 15 is soldered to the circuit board.

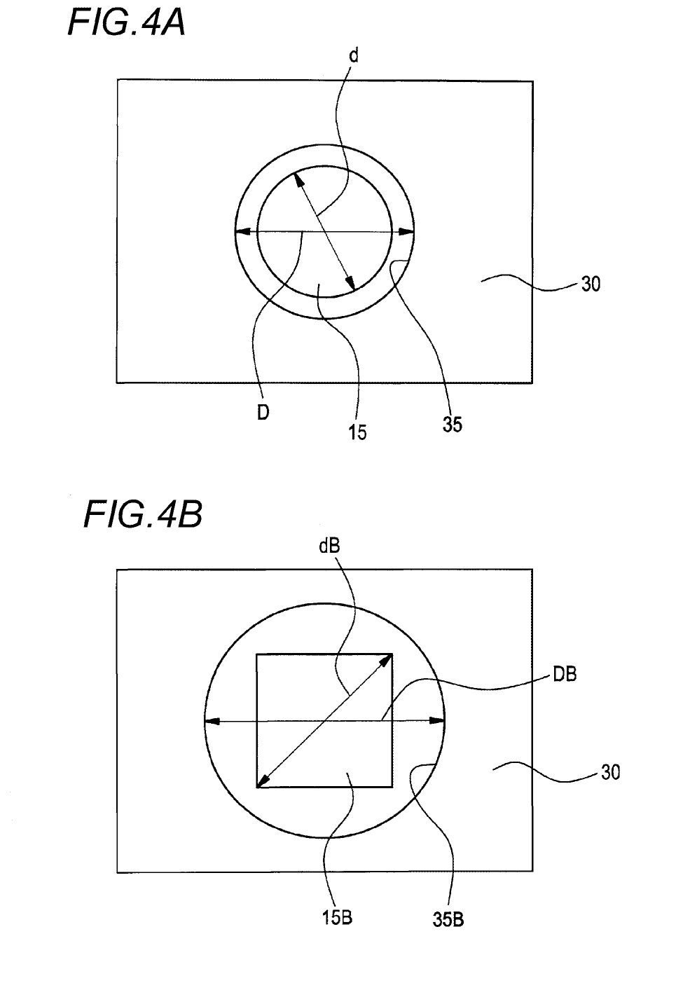

Further, since the rear leg part inserted into the through hole 35 of the circuit board 30 is not formed in a square pin shaped rear leg part 15B having a square form in cross-section as shown in FIG. 4B, but formed in the round pin shaped rear leg part 15 having the circular form in cross-section as shown in FIG. 4A, a diameter D of the through hole 35 can be made to be smaller than that of a through hole 35B into which the square pin shaped rear leg part 15B having the same sectional area is inserted. In the case of the square pin, as shown in FIG. 4B, since a length dB of a diagonal line of the square shaped section is a maximum dimension as shown in FIG. 4B, a diameter DB of the through hole 35B needs to be set so as to meet the length dB of the diagonal line. However, in the case of the round pin, since a maximum dimension (the diameter d) can be made to be smaller than the length dB of the diagonal line even in the same sectional area, a diameter D of the through hole 35 into which the round pin is inserted can be made to be smaller than the diameter DB of the through hole 35B into which the square pin is inserted. As a result, the pitch of the through hole 35 can be reduced, so that the integration of a circuit of the circuit board 30 and the miniaturization of the circuit board 30 can be achieved.

The round pin-shaped rear leg part 15 having a straight form maintained may be soldered to the circuit board. However, as shown by a two-dot chain line in FIG. 3, the rear leg part may be occasionally bent by 90° after the rear leg part 15 is press-fitted to the press-fit hole 20, and then, an end part thereof may be soldered to the through hole 35 of the circuit board 30.

Further, the present invention is not limited to the above-described embodiment and may be suitably modified and improved. In addition thereto, materials, forms, dimensions, numbers, arranged positions or the like of the component elements in the above-described embodiment may be arbitrary and are not limited, as long as they can achieve the present invention.

According to the present invention, a plating of a rear leg part can be prevented from peeling during a press-fit operation and a diameter of a through hole for soldering the rear leg part can be reduced, so that a circuit may be integrated and a circuit board may be miniaturized.

What is claimed is:

1. A press-fit terminal for a base board connector, the press-fit terminal comprising;
an electric connecting part which is provided in a front part of the press-fit terminal to be electrically connected to a mating connector terminal;
a rear leg part which is provided in a rear part of the press-fit terminal to be inserted and fixed to a through hole of a circuit board; and
an engaging part which is provided in an intermediate part between the electric connecting part and the rear leg part to be press-fitted to a press-fit hole of a wall part of a connector housing and engaged with the wall part of the connector housing, wherein
a range from the electric connecting part to the engaging part is formed in a shape of a square pin having a square form in cross-section, and
the rear leg part is formed in a shape of a round pin having a circular form in cross-section.

2. The press-fit terminal according to claim 1, wherein
the rear leg part is designed to have a diameter in cross-section being smaller than a minimum dimension between opposed inner wall surfaces of the press-fit hole of the connector housing.

3. The press-fit terminal according to claim 1, wherein
the engaging part includes;
a stopper protrusion which is protruded in a width direction of the press-fit terminal to regulate an inserting position of the terminal when the terminal is press-fitted to the press-fit hole of the connector housing; and
an engaging protrusion which is protruded in the width direction of the press-fit terminal to prevent the press-fit terminal from slipping out.

4. A fixing structure of a press-fit terminal to a connector housing,
the connector housing including a press-fit hole passing through a wall part of the connector housing, and
the press-fit terminal including:
an electric connecting part which is provided in a front part of the press-fit terminal to be electrically connected to a mating connector terminal;
a rear leg part which is provided in a rear part of the press-fit terminal to be inserted and fixed to a through hole of a circuit board; and
an engaging part which is provided in an intermediate part between the electric connecting part and the rear leg part, and press-fitted to the press-fit hole of the connector housing and engaged with the wall part of the connector housing, wherein
the rear leg part is inserted into the press-fit hole of the connector housing from a front side to a rear side of the press-fit hole to fix the press-fit terminal to the connecting housing,
a range from the electric connecting part to the engaging part of the press-fit terminal is formed in a shape of a square pin having a square form in cross-section, and
the rear leg part is formed in a shape of a round pin having a circular form in cross-section.

5. The fixing structure according to claim 4, wherein
the rear leg part has a diameter in cross-section being smaller than a minimum dimension between opposed inner wall surfaces of the press-fit hole of the connector housing.

6. The fixing structure according to claim 4, wherein
the engaging part includes:
a stopper protrusion which is protruded in a width direction of the press-fit terminal and abutted against an engaging wall of a front side of the press-fit hole to regulate an inserting position of the press-fit terminal when the terminal is press-fitted to the press-fit hole: and
an engaging protrusion which is protruded in the width direction of the press-fit terminal and engaged with an engaging wall of a rear side of the press-fit hole after the press-fit terminal passes through the press-fit hole to prevent the terminal from slipping out, wherein
the press-fit terminal is engaged with the connecting housing at a fixed position by the stopper protrusion and the engaging protrusion when the rear leg part is inserted into the press-fit hole of the connector housing from the front side to the rear side of the press-fit hole.
